(19) United States
(12) Patent Application Publication
(10) Pub. No.: US 2024/0404236 A1
(43) Pub. Date: Dec. 5, 2024

(54) OBJECT SEGMENTATION METHOD AND APPARATUS, AND ELECTRONIC DEVICE

(71) Applicant: BEIJING BAIDU NETCOM SCIENCE TECHNOLOGY CO., LTD., Beijing (CN)

(72) Inventor: Wenhua HAN, Beijing (CN)

(21) Appl. No.: 18/008,367

(22) PCT Filed: Dec. 8, 2021
(86) PCT No.: PCT/CN2021/136548

§ 371 Date: Dec. 5, 2022

(30) Foreign Application Priority Data
Jun. 30, 2021 (CN) 202110736166.X

(51) Int. Cl. G06V 10/26; G06V 10/77; G06V 10/80; G06V 10/82

(52) U.S. Cl. CPC G06V 10/26; G06V 10/7715; G06V 10/806; G06V 10/82

(57) ABSTRACT

An object segmentation method includes: generating and inputting a frame to be identified, a previous frame of the frame to be identified and a reference frame based on a video to be identified into an encoding network to generate a feature map of the frame to be identified, a target object feature map of the reference frame and a target object feature map of the previous frame; generating a first correlation matrix and a second correlation matrix; generating a first correlation feature map and a second correlation feature map; and generating an object segmentation image corresponding to a current frame based on the feature map of the frame to be identified.

### CROSS-REFERENCE TO RELATED APPLICATIONS

This application is a U.S. national phase application of International Application No. PCT/CN2021/136548, filed on Dec. 8, 2022, which claims priority to Chinese Patent Application No. 202110736166.X, filed on Jun. 30, 2021, the entire contents of which are incorporated herein by their references.

### TECHNICAL FIELD

The disclosure relates to a field of artificial intelligence (AI) technologies, especially to fields of computer vision and deep learning technologies, which can be used in smart city and smart traffic scenarios, and in particular to an object segmentation method, an object segmentation apparatus and an electronic device.

### BACKGROUND

With the development and application of AI-related technologies, more and more fields have shown a strong demand for intelligent and automatic technologies, which include the short video field. In the short video field, the video object segmentation method has a good prospect of use, removal of the specified object in the video and background blur are dependent on the video object segmentation method. Therefore, the development of the video object segmentation method is of great significance to the intelligence of short video processing and special effects processing.

### SUMMARY

According to a first aspect of the disclosure, an object segmentation method is provided. The method includes:
generating a frame to be identified, a previous frame of the frame to be identified and a reference frame based on a video to be identified, in which the reference frame is a first frame of the video to be identified;
generating a feature map of the frame to be identified, a target object feature map of the reference frame and a target object feature map of the previous frame by inputting the frame to be identified, the previous frame and the reference frame into an encoding network;
generating a first correlation matrix and a second correlation matrix based on the feature map of the frame to be identified, the target object feature map of the reference frame and the target object feature map of the previous frame;
generating a first correlation feature map and a second correlation feature map based on the first correlation matrix, the second correlation matrix, the target object feature map of the reference frame and the target object feature map of the previous frame; and
generating an object segmentation image corresponding to a current frame based on the first correlation feature map, the second correlation feature map and the feature map of the frame to be identified.

According to a second aspect of the disclosure, an electronic device is provided. The electronic device includes: at least one processor and a memory communicatively coupled to the at least one processor. The memory stores instructions executable by the at least one processor, and when the instructions are executed by the at least one processor, the method of the first aspect of the disclosure is implemented.

According to a third aspect of the disclosure, a non-transitory computer-readable storage medium having computer instructions stored thereon is provided. The computer instructions are configured to cause a computer to implement the method of the first aspect of the disclosure.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure.

FIG. 1 is a flowchart illustrating an object segmentation method according to some embodiments of the disclosure.

FIG. 2 is a flowchart illustrating an object segmentation method according to some embodiments of the disclosure.

FIG. 3 is a flowchart illustrating an object segmentation method according to some embodiments of the disclosure.

FIG. 4 is a flowchart illustrating an object segmentation method according to some embodiments of the disclosure.

FIG. 5 is a flowchart illustrating an object segmentation method according to some embodiments of the disclosure.

FIG. 6 is a flowchart illustrating an object segmentation method according to some embodiments of the disclosure.

FIG. 7 is a flowchart illustrating an object segmentation method according to some embodiments of the disclosure.

FIG. 8 is a schematic diagram illustrating an object segmentation apparatus according to some embodiments of the disclosure.

FIG. 9 is a schematic diagram illustrating an object segmentation apparatus according to some embodiments of the disclosure.

FIG. 10 is a schematic diagram illustrating an object segmentation apparatus according to some embodiments of the disclosure.

FIG. 11 is a schematic diagram illustrating an object segmentation apparatus according to some embodiments of the disclosure.

FIG. 12 is a schematic diagram illustrating an object segmentation apparatus according to some embodiments of the disclosure.

FIG. 13 is a schematic diagram illustrating an object segmentation apparatus according to some embodiments of the disclosure.

FIG. 14 is a schematic diagram illustrating an object segmentation apparatus according to some embodiments of the disclosure.

FIG. 15 is a schematic diagram illustrating an electronic device used to implement the target segmentation method according to some embodiments of the disclosure.

FIG. 16 is a schematic diagram illustrating a target segmentation apparatus according to some embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

With the development and application of AI-related technologies, more and more fields have shown a strong demand for intelligent and automatic technologies, which include the short video field. In the short video field, the video object segmentation method has a good prospect of use, removal of the specified object in the video and background blur are dependent on the video object segmentation method. Therefore, the development of the video object segmentation method is of great significance to the intelligence of short video processing and special effects processing.

In the existing video object segmentation method, the occlusion problem of a specified object in the video is a relatively difficult problem. If an object is sometimes occluded and sometimes appears, incorrect segmentation of the target object will occur. Therefore, if an object is occluded and the object reappears in subsequent frames, it easily leads to incorrect segmentation of the target object. There is no particularly mature method to deal with this occlusion problem in the existing common solutions.

A common method is to generate an instance attention by reading the information of historical frames and extracting from the historical frames, vectors of all positions where the target object appears. However, this method will obtain a sum of the extracted object vectors, compress the vector of (c,h,w) into the vector of (c1,1), and then add the vector of (c,1,1) into an auxiliary network in the network for the object segmentation. In this way, the problem of object occlusion can be solved to a certain extent, but when the method is processed, after compressing the extracted vectors into (c, 1, 1), all the positions, shapes, and adjacent vector correlation and other related information of the object are lost, so the method still needs to be improved.

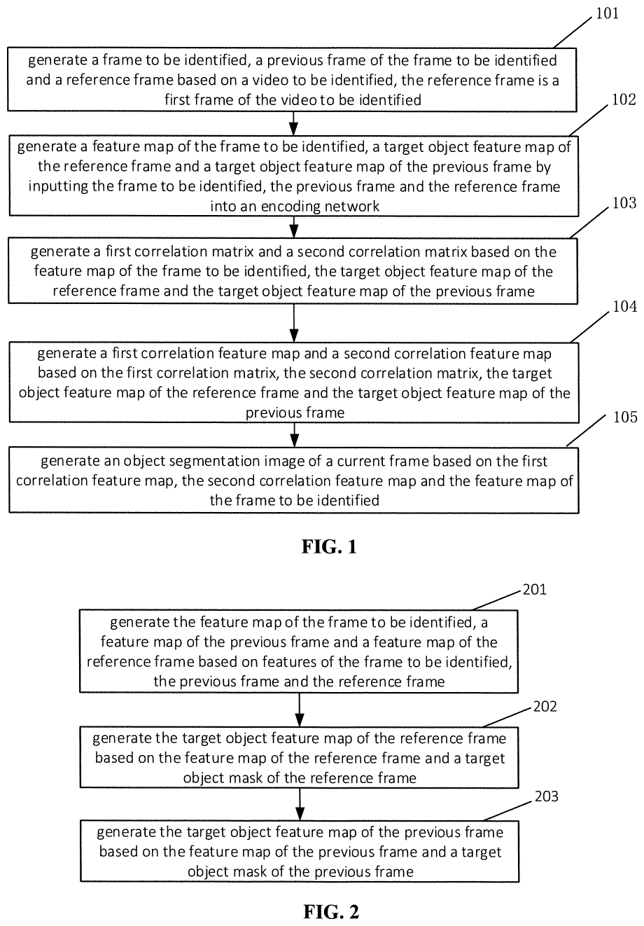

FIG. 1 is a flowchart illustrating an object segmentation method according to an embodiment of the disclosure. As illustrated in FIG. 1, the object segmentation method includes the following.

In step 101, a frame to be identified, a previous frame of the frame to be identified and a reference frame are generated based on a video to be identified, the reference frame is a first frame of the video to be identified.

The disclosure can be applied in smart city and smart traffic scenarios. Smart city uses information and communication technology to sense, analyze, and integrate various key information of the city's operational core systems. The construction of smart city requires the realization of comprehensive perception, ubiquitous interconnection, universal computing and integrated applications through new-generation information technology applications such as the Internet of Things and cloud computing represented by mobile technologies. Important perception information of the smart city is the video information obtained by surveillance cameras.

In embodiments of the disclosure, the video information can be further mined. Firstly, the video to be identified is recorded by a camera, and one of the frames is selected as the frame to be identified. The historical frames are utilized in the disclosure, that is, a previous frame of the frame to be identified and a reference frame are utilized to enhance features of a target object in the frame to be identified. The previous frame is a previous frame adjacent to the frame to be identified, and the reference frame is a first frame of the video to be identified.

In step 102, a feature map of the frame to be identified, a target object feature map of the reference frame and a target object feature map of the previous frame are generated by inputting the frame to be identified, the previous frame and the reference frame into an encoding network.

The encoding network is encoders in a neural network. The encoding network is configured to down sample the frame to be identified, the previous frame and the reference frame to extract high-dimensional features of the frame to be identified, high-dimensional features of the previous frame and high-dimensional features of the reference frame. That is, the feature map of the frame to be identified is generated.

Meanwhile, in order to obtain the correlation matrix subsequently, the disclosure uses a target object mask of the previous frame and a target object mask of the reference frame, to obtain the target object feature map of the reference frame and the target object feature map of the previous frame.

In step 103, a first correlation matrix and a second correlation matrix are generated based on the feature map of the frame to be identified, the target object feature map of the reference frame and the target object feature map of the previous frame.

The correlation matrix is a paradigm, each element in the matrix is used to represent the correlation between a local feature vector in a feature map and a local feature vector in another feature map and is usually a dot product of these two local feature vectors. The size of the correlation matrix composed of two feature maps each having the size of H*W*d is (H*W)*(H*W), where H is the height, W is the width, and d is the number of channels. The correlation is a basis for measuring a feature matching degree. Features provide different representations according to different tasks, which are usually semantic features based on shape, color, and texture.

The disclosure uses the correlation matrices to represent the correlations between pixels of the target object feature map of the reference image and pixels of the feature map of the frame to be identified and the correlations between pixels of the target object feature map of the previous frame and pixels in the feature map of the frame to be identified. The stronger the correlation between a feature vector corresponding to a pixel in the feature map of the frame to be identified and a feature vector corresponding to a pixel in the target object feature map of the reference frame and the correlation between a feature vector corresponding to a pixel in the feature map of the frame to be identifier and a feature vector corresponding to a pixel in the target object feature map of the previous frame, the more likely the pixel in the feature map of the frame to be identified is the pixel of the target object.

In step 104, a first correlation feature map and a second correlation feature map are generated based on the first correlation matrix, the second correlation matrix, the target object feature map of the reference frame and the target object feature map of the previous frame.

The first correlation matrix, the second correlation matrix and the feature map of the frame to be identified can generate an object feature map of the frame to be identified, and the features of the feature map of the frame to be identified can be enhanced according to the correlation matrices, to improve the detection accuracy of the target object.

In step 105, an object segmentation image of a current frame is generated based on the first correlation feature map, the second correlation feature map and the feature map of the frame to be identified.

The distribution of the first correlation feature map and the distribution of the second correlation feature map are multiplied respectively point to point by corresponding pixels in the feature map of the frame to be identified to generate the first correlation feature map and the second correlation feature map. The first correlation feature map, the second correlation feature map and the feature map of the frame to be identified are concatenated to enhance the features of the pixels related to the target object, so as to generate the fusion feature map.

The object segmentation image can be obtained by inputting the fusion feature map into a decoder. The decoder is used for up sample the fusion feature map, to restore the object segmentation image to have the same size as the frame to be identified. The pixels belonging to the target object in the frame to be identified are obtained.

The correlation matrices associated with the feature maps of the frame to be identified are obtained based on the target object feature map of the reference frame and the target object feature map of the previous frame. Therefore, the attention is focused on the target object, so as to improve the accuracy of recognizing the target object.

FIG. 2 is a flowchart illustrating an object segmentation method according to some embodiments of the disclosure. As illustrated in FIG. 2, the object segmentation method includes the following.

In step 201, a feature map of a frame to be identified, a feature map of a previous frame and a feature map of a reference frame are generated based on features of the frame to be identified, features of the previous frame and features of the reference frame.

In the disclosure, a neural network is utilized to extract the features of the frame to be identified, the features of the previous frame and the features of the reference frame. There are various well-known methods for extracting the features, which are not limited in the disclosure.

In a possible embodiment, a random downsampling method is used for extracting the features to generate the feature map of the frame to be identified, the feature map of the previous frame and the feature map of the reference frame.

In step 202, a target object feature map of the reference frame is generated based on the feature map of the reference frame and a target object mask of the reference frame.

The target object mask of the reference frame has been obtained through the object segmentation method, and the pixels of target object mask of the reference frame are multiplied point-to-point by the pixels in the feature map of the reference frame, to generate the target object feature map of the reference frame. In this step, the target object feature map of the reference frame only containing the feature map of the target object can be acquired, so as to facilitate subsequent acquisition of the first correlation matrix.

In the disclosure, the term “multiplied point-to-point by” or “performing point-to-point multiplication” means that the multiplier and the multiplicand have the same coordinate.

That is, for each pixel of the target object mask of the reference frame, the element is multiplied by a pixel having the same coordinate as that element and contained in the feature map of the reference frame to generate the target object feature map of the reference frame. For example, the pixel at the coordinate (m, n) of the target object mask of the reference frame is multiplied by the pixel at the same coordinate (m, n) of the feature map of the reference frame to generate the target object feature map of the reference frame.

In step 203, the target object feature map of the previous frame is generated based on the feature map of the previous frame and a target object mask of the previous frame.

The target object mask of the previous frame has been obtained through the object segmentation method, and the pixels of the target object mask of the previous frame is multiplied point-to-point by the pixels of the feature map of the reference frame, to generate the target object feature map of the previous frame. In this step, the target object feature map of the previous frame only containing the feature map of the target object can be acquired, so as to facilitate subsequent acquisition of the second correlation matrix.

That is, for each pixel of the target object mask of the previous frame, the element is multiplied by a pixel having the same coordinate as that element and contained in the feature map of the previous frame to generate the target object feature map of the previous frame. For example, the pixel at the coordinate (m, n) of the target object mask of the previous frame is multiplied by the pixel at the same coordinate (m, n) of the feature map of the previous frame to generate the target object feature map of the previous frame.

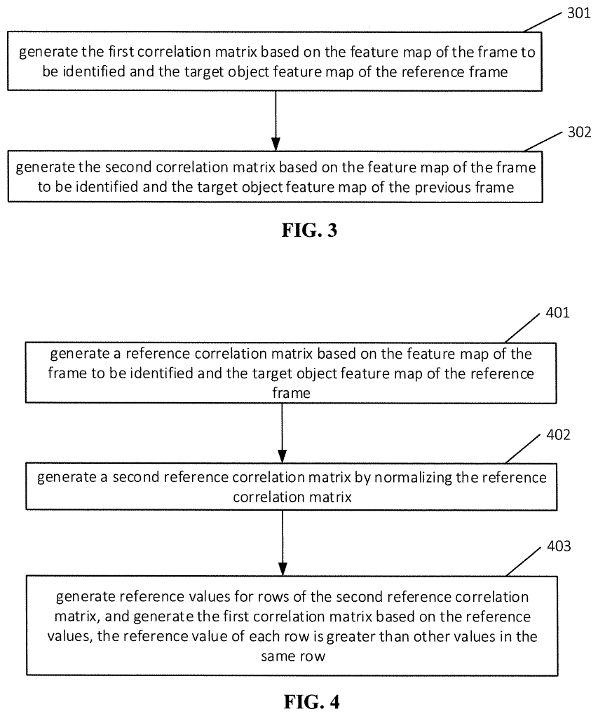

FIG. 3 is a flowchart illustrating an object segmentation method according to some embodiments of the disclosure. As illustrated in FIG. 3, the object segmentation method includes the following.

In step 301, the first correlation matrix is generated based on the feature map of the frame to be identified and the target object feature map of the reference frame.

In the disclosure, the first correlation matrix that is generated based on the feature map of the frame to be identified and the target object feature map of the reference frame represents the correlations between the pixels in the feature map of the frame to be identified and the pixels belonging to the target object contained in the target object feature map of the reference frame, so as to facilitate subsequent feature extraction.

In step 302, the second correlation matrix is generated based on the feature map of the frame to be identified and the target object feature map of the previous frame.

In the disclosure, the second correlation matrix that is generated based on the feature map of the frame to be identified and the target object feature map of the previous frame represents the correlations between the pixels in the feature map of the frame to be identified and the pixels belonging to the target object contained in the target object feature map of the previous frame, so as to facilitate subsequent feature extraction.

FIG. 4 is a flowchart illustrating an object segmentation method according to some embodiments of the disclosure. As illustrated in FIG. 4, the object segmentation method includes the following.

In step 401, a reference correlation matrix is generated based on the feature map of the frame to be identified and the target object feature map of the reference frame.

The reference correlation matrix can be generated based on the feature map of the frame to be identified and the target object feature map of the reference frame in various methods for generating the correlation matrix. In a possible implementation, the Euclidean distances between the feature vectors corresponding to the pixels in the feature map of the frame to be identified and the feature vectors corresponding to the pixels in the target object feature map of the reference frame are calculated, and the Euclidean distances are used as values of elements of the reference correlation matrix to generate the reference correlation matrix.

In step 402, a second reference correlation matrix is generated by normalizing the reference correlation matrix.

Normalizing the reference correlation matrix can reduce the error of subsequent object segmentation. There are various normalizing methods. In a possible implementation, a softmax function is used to normalize the reference correlation matrix. After normalizing the reference correlation matrix, the second reference correlation matrix is generated. For each row of the second reference correlation matrix, a sum of values of all elements is 1.

In step 403, reference values are generated for rows of the second reference correlation matrix, and the first correlation matrix is generated based on the reference values. The reference value of each row is greater than other values in the same row.

In order to remove pixels with low correlation, in the disclosure, only the element with the largest value is retained in each row of the second reference correlation matrix. The value of the element with the largest value is the reference value. In a possible implementation, the second reference frame correlation matrix is a matrix of (h×w, N), after retaining the reference values, the matrix of (h×w, 1) is generated, and after performing the reshaping, the first correlation matrix of (h, w) is obtained.

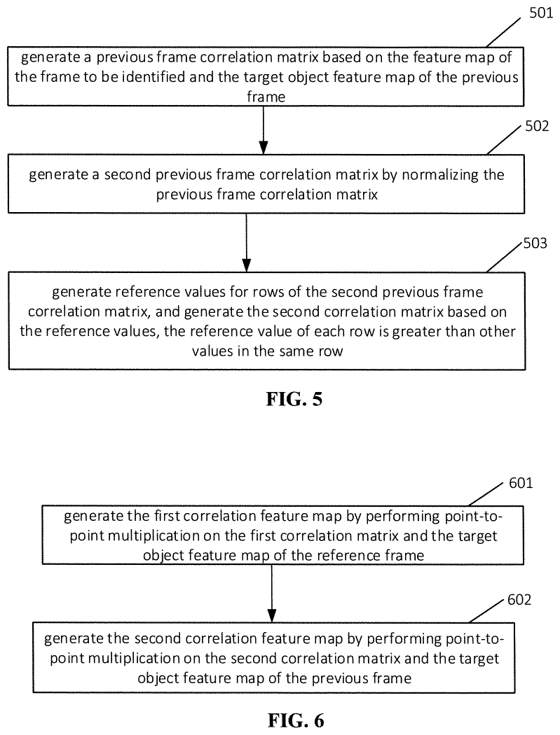

FIG. 5 is a flowchart illustrating an object segmentation method according to some embodiments of the disclosure. As illustrated in FIG. 5, the object segmentation method includes the following.

In step 501, a previous frame correlation matrix is generated based on the feature map of the frame to be identified and the target object feature map of the previous frame.

The previous frame correlation matrix can be generated based on the feature map of the frame to be identified and the target object feature map of the previous frame in various methods for generating the correlation matrix. In a possible implementation, the Euclidean distances between the feature vectors corresponding to the pixels in the feature map of the frame to be identified and the feature vectors corresponding to the pixels in the target object feature map of the previous frame are calculated, and the Euclidean distances are used as values of elements of the previous frame correlation matrix to generate the previous frame correlation matrix.

In step 502, a second previous frame correlation matrix is generated by normalizing the previous frame correlation matrix.

Normalizing the previous frame correlation matrix can reduce the error of subsequent object segmentation. There are various normalizing methods. In a possible implementation, a softmax function is used to normalize the previous frame correlation matrix. After normalizing the previous frame correlation matrix, the second previous frame correlation matrix is generated. For each row of the second previous frame correlation matrix, a sum of values of all elements is

1.

In step 503, reference values are generated for each row of the second previous frame correlation matrix, and the second correlation matrix is generated based on the reference values. The reference value of each row is greater than other values in the same row.

In order to remove pixels with low correlation, in the disclosure, only the element with the largest value is retained in each row in the second previous frame correlation matrix. The value of the element with the largest value is the reference value. In a possible implementation, the second previous frame correlation matrix is a matrix of (h×w, N), after retaining the reference values, the matrix of (h×w, 1) is generated, and after performing the reshaping, the second correlation matrix of (h, w) is obtained.

FIG. 6 is a flowchart illustrating an object segmentation method according to some embodiments of the disclosure. As illustrated in FIG. 6, the object segmentation method includes the following.

In step 601, the first correlation feature map is generated by performing point-to-point multiplication on the first correlation matrix and the target object feature map of the reference frame.

In order to enhance the features in the target object feature map of the reference frame, in the disclosure, the elements of first correlation matrix are multiplied by the pixels in the target object feature map of the reference frame point to point to obtain the first correlation feature map. The first correlation matrix has the same size as the target object feature map of the reference frame.

In step 602, the second correlation feature map is generated by performing point-to-point multiplication on the second correlation matrix and the target object feature map of the previous frame.

In order to enhance the features in the target object feature map of the previous frame, in the disclosure, the elements of the second correlation matrix are multiplied by the pixels in the target object feature map of the previous frame point to point to obtain the second correlation feature map. The second correlation matrix has the same size as the target object feature map of the previous frame.

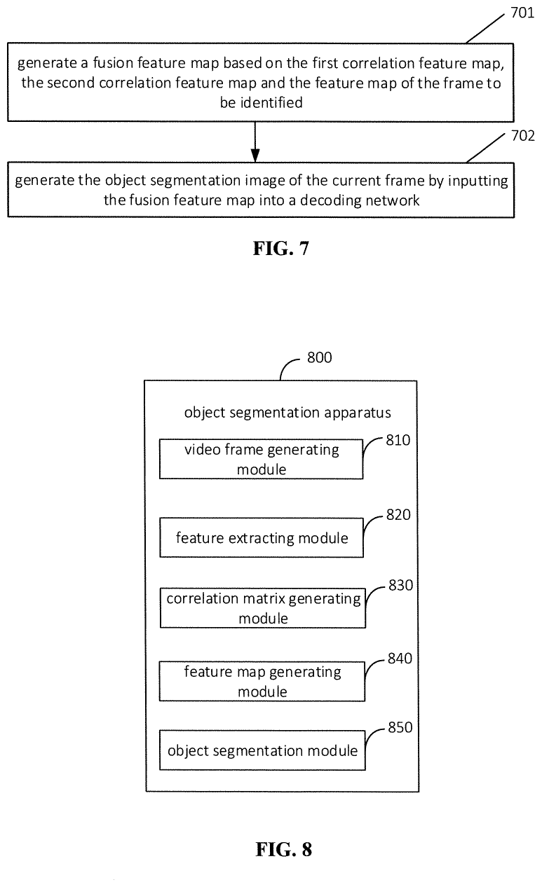

FIG. 7 is a flowchart illustrating an object segmentation method according to some embodiments of the disclosure. As illustrated in FIG. 7, the object segmentation method includes the following.

In step 701, a fusion feature map is generated based on the first correlation feature map, the second correlation feature map and the feature map of the frame to be identified.

In order to enhance the features of the target object, in the disclosure, the first correlation feature map, the second correlation feature map, and the features of the feature map of the frame to be identified are fused together to generate the fusion feature map. There are various fusion methods. In a possible implementation, the first correlation feature map, the second correlation feature map, and the feature map of the frame to be identified are concatenated, to increase the number of channels per pixel to generate the fusion feature map.

In step 702, the object segmentation image of the current frame is generated by inputting the fusion feature map into a decoding network.

The decoding network is used to up sample the fusion feature map to restore features, and the pixels belonging to the target object can be obtained based on the object segmentation image.

In some examples, generating the fusion feature map based on the first correlation feature map, the second correlation feature map and the feature map of the frame to be identified, includes generating the fusion feature map by concatenating the first correlation feature map, the second correlation feature map and the feature map of the frame to be identified.

The number of dimensions can be increased by the concatenating to fuse the features can facilitate subsequent object segmentation.

FIG. 8 is a schematic diagram illustrating an object segmentation apparatus according to some embodiments of the disclosure. As illustrated in FIG. 8, the object segmentation apparatus 800 includes: a video frame generating module 810, a feature extracting module 820, a correlation matrix generating module 830, a feature map generating module 840 and an object segmentation module 850.

The video frame generating module 810 is configured to generate a frame to be identified, a previous frame of the frame to be identified and a reference frame based on a video to be identified. The reference frame is a first frame of the video to be identified.

The disclosure can be applied in smart city and smart traffic scenarios. Smart city uses information and communication technology to sense, analyze, and integrate various key information of the city's operational core systems. The construction of smart city requires the realization of comprehensive perception, ubiquitous interconnection, universal computing and integrated applications through new-generation information technology applications such as the Internet of Things and cloud computing represented by mobile technologies. Important perception information of the smart city is the video information obtained by surveillance cameras.

In embodiments of the disclosure, the video information can be further mined. Firstly, the video to be identified is recorded by a camera, and one of the frames is selected as the frame to be identified. The historical frames are utilized in the disclosure, that is, a previous frame of the frame to be identified and a reference frame are utilized to enhance features of a target object in the frame to be identified. The previous frame is a previous frame adjacent to the frame to be identified, and the reference frame is a first frame of the video to be identified.

The feature extracting module 820 is configured to generate a feature map of the frame to be identified, a target object feature map of the reference frame and a target object feature map of the previous frame by inputting the frame to be identified, the previous frame and the reference frame into an encoding network.

The encoding network is encoders in a neural network. The encoding network is used to down sample the frame to be identified, the previous frame and the reference frame to extract high-dimensional features from the frame to be identified, from the previous frame and from the reference frame. That is, the feature map of the frame to be identified is generated.

Meanwhile, in order to obtain the correlation matrix subsequently, the disclosure uses a target object mask of the previous frame and a target object mask of the reference frame, to obtain the target object feature map of the reference frame and the target object feature map of the previous frame.

The correlation matrix generating module 830 is configured to generate a first correlation matrix and a second correlation matrix based on the feature map of the frame to be identified, the target object feature map of the reference frame and the target object feature map of the previous frame.

The correlation matrix is a paradigm, each element in the matrix is used to represent the correlation between a local feature vector in a feature map and a local feature vector in another feature map and is usually a dot product of these two local feature vectors. The size of the correlation matrix composed of two feature maps each having the size of H*W*d is (H*W)*(H*W), where H is the height, W is the width, and d is the number of channels. The correlation is a basis for measuring a feature matching degree. Features provide different representations according to different tasks, which are usually semantic features based on shape, color, and texture.

The disclosure uses the correlation matrices to represent the correlations between pixels of the target object feature map of the reference image and pixels of the feature map of the frame to be identified and the correlations between pixels of the target object feature map of the previous frame and pixels in the feature map of the frame to be identified. The stronger the correlation between a feature vector corresponding to a pixel in the feature map of the frame to be identified and a feature vector corresponding to a pixel in the target object feature map of the reference frame and the correlation between a feature vector corresponding to a pixel in the feature map of the frame to be identifier and a feature vector corresponding to a pixel in the target object feature map of the previous frame are, the more likely the pixel in the feature map of the frame to be identified is the pixel of the target object.

The feature map generating module 840 is configured to generate a first correlation feature map and a second correlation feature map based on the first correlation matrix, the second correlation matrix, the target object feature map of the reference frame and the target object feature map of the previous frame.

The first correlation matrix, the second correlation matrix and the feature map of the frame to be identified can generate an object feature map of the frame to be identified, and the features of the feature map of the frame to be identified can be enhanced according to the correlation matrices, to improve the detection accuracy of the target object.

The object segmentation module 850 is configured to generate an object segmentation image of a current frame based on the first correlation feature map, the second correlation feature map and the feature map of the frame to be identified.

Elements of the first correlation feature map and elements of the second correlation feature map are multiplied respectively point to point by corresponding pixels in the feature map of the frame to be identified to generate the first correlation feature map and the second correlation feature map. The first correlation feature map, the second correlation feature map and the feature map of the frame to be identified are concatenated to enhance the features of the pixels related to the target object, so as to generate the fusion feature map.

The object segmentation image can be obtained by inputting the fusion feature map into a decoder. The decoder is used for up sample the fusion feature map, to restore the object segmentation image to have the same size as the frame to be identified. The pixels belonging to the target object in the frame to be identified are obtained.

FIG. 9 is a schematic diagram illustrating an object segmentation apparatus according to some embodiments of the disclosure. As illustrated in FIG. 9, the object segmentation apparatus 900 includes: a feature extracting sub-module 910, a first mask sub-module 920 and a second mask sub-module 930.

The feature extracting sub-module 910 is configured to generate a feature map of the frame to be identified, a feature map of a previous frame and a feature map of a reference frame by extracting features of the frame to be identified, features of the previous frame and features of the reference frame.

In the disclosure, a neural network is utilized to extract the features of the frame to be identified, the features of the previous frame and the features of the reference frame. There are various well-known methods for extracting the features, which are not limited in the disclosure.

In a possible embodiment, a random down sampling method is used for extracting the features to generate the feature map of the frame to be identified, the feature map of the previous frame and the feature map of the reference frame.

The first mask sub-module 920 is configured to generate a target object feature map of the reference frame based on the feature map of the reference frame and a target object mask of the reference frame.

The target object mask of the reference frame has been obtained through the object segmentation method, and the pixels of target object mask of the reference frame are multiplied point-to-point by the pixels in the feature map of the reference frame, to generate the target object feature map of the reference frame. In this step, the target object feature map of the reference frame only containing the feature map of the target object can be acquired, so as to facilitate subsequent acquisition of the first correlation matrix.

The second mask sub-module 930 is configured to generate the target object feature map of the previous frame based on the feature map of the previous frame and a target object mask of the previous frame.

The target object mask of the previous frame has been obtained through the object segmentation method, and the pixels of the target object mask of the previous frame is multiplied point-to-point by the pixels of the feature map of the reference frame, to generate the target object feature map of the previous frame. In this step, the target object feature map of the previous frame only containing the feature map of the target object can be acquired, so as to facilitate subsequent acquisition of the second correlation matrix.

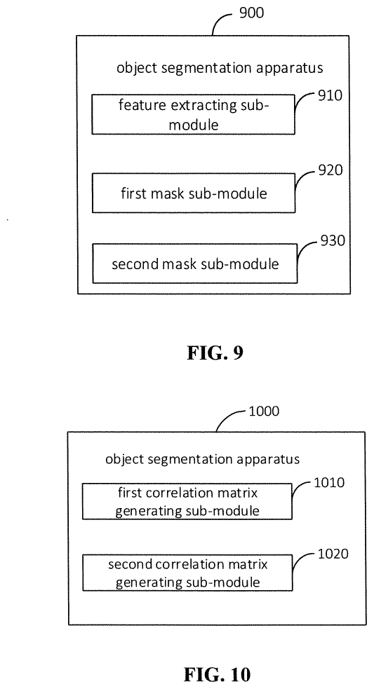

FIG. 10 is a schematic diagram illustrating an object segmentation apparatus according to some embodiments of the disclosure. As illustrated in FIG. 10, the object segmentation apparatus 1000 includes: a first correlation matrix generating sub-module 1010 and a second correlation matrix generating sub-module 1020.

The first correlation matrix generating sub-module 1010 is configured to generate the first correlation matrix based on the feature map of the frame to be identified and the target object feature map of the reference frame.

In the disclosure, the first correlation matrix that is generated based on the feature map of the frame to be identified and the target object feature map of the reference frame represents the correlations between the pixels in the feature map of the frame to be identified and the pixels belonging to the target object contained in the target object feature map of the reference frame, so as to facilitate subsequent feature extraction.

The second correlation matrix generating sub-module 1020 is configured to generate the second correlation matrix based on the feature map of the frame to be identified and the target object feature map of the previous frame.

In the disclosure, the second correlation matrix that is generated based on the feature map of the frame to be identified and the target object feature map of the previous frame represents the correlations between the pixels in the feature map of the frame to be identified and the pixels belonging to the target object contained in the target object feature map of the previous frame, so as to facilitate subsequent feature extraction.

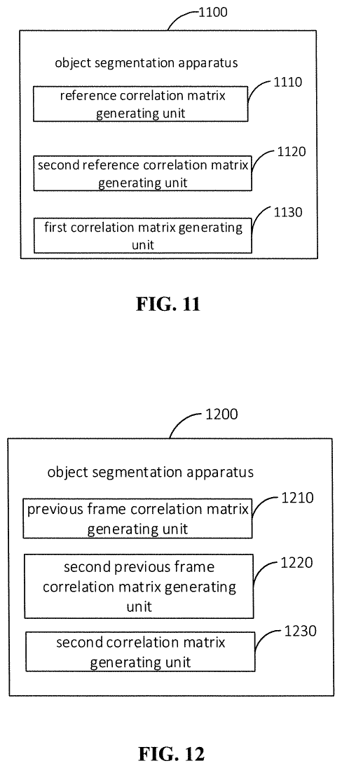

FIG. 11 is a schematic diagram illustrating an object segmentation apparatus according to some embodiments of the disclosure. As illustrated in FIG. 11, the object segmentation apparatus 1100 includes: a reference correlation matrix generating unit 1110, a second reference correlation matrix generating unit 1120 and a first correlation matrix generating unit 1130.

The reference correlation matrix generating unit 1110 is configured to generate a reference correlation matrix based on the feature map of the frame to be identified and the target object feature map of the reference frame.

The reference correlation matrix can be generated based on the feature map of the frame to be identified and the target object feature map of the reference frame in various methods for generating the correlation matrix. In a possible implementation, the Euclidean distances between the feature vectors corresponding to the pixels in the feature map of the frame to be identified and the feature vectors corresponding to the pixels in the target object feature map of the reference frame are calculated, and the Euclidean distances are used as values of elements of the reference correlation matrix to generate the reference correlation matrix.

The second reference correlation matrix generating unit 1120 is configured to generate a second reference correlation matrix by normalizing the reference correlation matrix.

Normalizing the reference correlation matrix can reduce the error of subsequent object segmentation. There are various normalizing methods. In a possible implementation, a softmax function is used to normalize the reference correlation matrix. After normalizing the reference correlation matrix, the second reference correlation matrix is generated. For each row of the second reference correlation matrix, a sum of values of all elements is 1.

The first correlation matrix generating unit 1130 is configured to generate reference values for rows of the second reference correlation matrix, and generate the first correlation matrix based on the reference values. The reference value of each row is greater than other values in the same row.

In order to remove pixels with low correlation, in the disclosure, only the element with the largest value is retained in each row of the second reference correlation matrix. The value of the element with the largest value is the reference value. In a possible implementation, the second reference frame correlation matrix is a matrix of (h×w, N), after retaining the reference values, the matrix of (h×w, 1) is generated, and after performing the reshaping, the first correlation matrix of (h, w) is obtained.

FIG. 12 is a schematic diagram illustrating an object segmentation apparatus according to some embodiments of the disclosure. As illustrated in FIG. 12, the object segmentation apparatus 1200 includes: a previous frame correlation matrix generating unit 1210, a second previous frame correlation matrix generating unit 1220 and a second correlation matrix generating unit 1230.

The previous frame correlation matrix generating unit 1210 is configured to generate a previous frame correlation matrix based on the feature map of the frame to be identified and the target object feature map of the previous frame.

The previous frame correlation matrix can be generated based on the feature map of the frame to be identified and the target object feature map of the previous frame in various methods for generating the correlation matrix. In a possible implementation, the Euclidean distances between the feature vectors corresponding to the pixels in the feature map of the frame to be identified and the feature vectors corresponding to the pixels in the target object feature map of the previous frame are calculated, and the Euclidean distances are used as values of elements of the previous frame correlation matrix to generate the previous frame correlation matrix.

The second previous frame correlation matrix generating unit 1220 is configured to generate a second previous frame correlation matrix by normalizing the previous frame correlation matrix.

Normalizing the previous frame correlation matrix can reduce the error of subsequent object segmentation. There are various normalizing methods. In a possible implementation, a softmax function is used to normalize the previous frame correlation matrix. After normalizing the previous frame correlation matrix, the second previous frame correlation matrix is generated. For each row of the second previous frame correlation matrix, a sum of values of all elements is 1.

The second correlation matrix generating unit 1230 is configured to generate reference values for each row of the second previous frame correlation matrix, and generate the second correlation matrix based on the reference values. The reference value of each row is greater than other values in the same row.

In order to remove pixels with low correlation, in the disclosure, only the element with the largest value is retained in each row in the second previous frame correlation matrix. The value of the element with the largest value is the reference value. In a possible implementation, the second previous frame correlation matrix is a matrix of (h×w, N), after retaining the reference values, the matrix of (h×w, 1) is generated, and after performing the reshaping, the second correlation matrix of (h, w) is obtained.

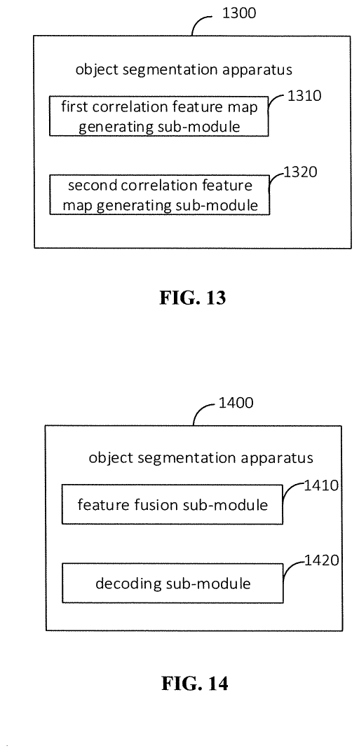

FIG. 13 is a schematic diagram illustrating an object segmentation apparatus according to some embodiments of the disclosure. As illustrated in FIG. 13, the object segmentation apparatus 1300 includes: a first correlation feature map generating sub-module 1310 and a second correlation feature map generating sub-module 1320.

The first correlation feature map generating sub-module 1310 is configured to generate the first correlation feature map by performing point-to-point multiplication on the first correlation matrix and the target object feature map of the reference frame.

In order to enhance the features in the target object feature map of the reference frame, in the disclosure, the elements of first correlation matrix are multiplied by the pixels in the target object feature map of the reference frame point to point to obtain the first correlation feature map. The first correlation matrix has the same size as the target object feature map of the reference frame.

The second correlation feature map generating sub-module 1320 is configured to generate the second correlation feature map by performing point-to-point multiplication on the second correlation matrix and the target object feature map of the previous frame.

In order to enhance the features in the target object feature map of the previous frame, in the disclosure, the elements of the second correlation matrix are multiplied by the pixels in the target object feature map of the previous frame point to point to obtain the second correlation feature map. The second correlation matrix has the same size as the target object feature map of the previous frame.

FIG. 14 is a schematic diagram illustrating an object segmentation apparatus according to some embodiments of the disclosure. As illustrated in FIG. 14, the object segmentation apparatus 1400 includes: a feature fusion sub-module 1410 and a decoding sub-module 1420.

The feature fusion sub-module 1410 is configured to generate a fusion feature map based on the first correlation feature map, the second correlation feature map and the feature map of the frame to be identified.

In order to enhance the features of the target object, in the disclosure, the first correlation feature map, the second correlation feature map, and the features of the feature map of the frame to be identified are fused together to generate the fusion feature map. There are various fusion methods. In a possible implementation, the first correlation feature map, the second correlation feature map, and the feature map of the frame to be identified are concatenated, to increase the number of channels per pixel to generate the fusion feature map.

The decoding sub-module 1420 is configured to obtain the object segementation image by inputting the fusion feature map into a decoding network.

The decoding network is used to up sample the fusion feature map to restore features, and the pixels belonging to the target object can be obtained based on the object segmentation image.

In some examples, the feature fusion sub-module includes: a feature fusion unit, configured to generate the fusion feature map by concatenating the first correlation feature map, the second correlation feature map and the feature map of the frame to be identified.

The number of dimensions can be increased by the concatenating to fuse the features can facilitate subsequent object segmentation.

FIG. 16 is a schematic diagram illustrating an object segmentation apparatus according to some embodiments of the disclosure. As illustrated in FIG. 16, the first frame represented by ref_im, the previous frame represented by pre_im and the current frame represented by cur_im are input into the network. Through the feature extraction network, vector maps of the first frame, the previous frame and the current frame are obtained respectively, which are represented by ref_emb, pre_emb and cur_emb correspondingly, and the sizes of the vectors are all (c, h, w), where c is the number of channels, h is the height, and w is the width.

Then, according to the target object mask represented by ref_m of the first frame and the target object mask represented by pre_m of the previous frame, the vector map represented by ref_e of the corresponding pixel positions of the target object is extracted from the vector map of the first frame and the vector map represented by ref_e of the corresponding pixel positions of the target object is extracted from the vector map of the previous frame.

The correlation matrixes of the vector map of the current frame relative to the first frame and the previous frame are calculated respectively, and the normalized correlation representation of each pixel position of the current frame relative to each pixel position of the first frame and the normalized correlation representation of each pixel position of the current frame relative to each pixel position of the previous frame is obtained through softmax calculation. The maximum value of each row in the normalized correlation matrix is used to construct a matrix of 1×(c×h), and then the matrix of 1×(c×h) is restored to a matrix of cxh, that is, cur_ref and cur_pre.

According to the cur_ref and cur_pre, the vector maps of the first frame and the previous frame are updated (i.e., concat), to obtain ref_e1 and pre_e1.

Finally, the ref_e1 and pre_e1 are concatenated with the cur_emb and input into the decoding network, to obtain the object segmentation image. The pixels belonging to the target object can be obtained according to the object segmentation image.

According to an embodiment of the disclosure, the disclosure also provides an electronic device, a readable storage medium and a computer program product.

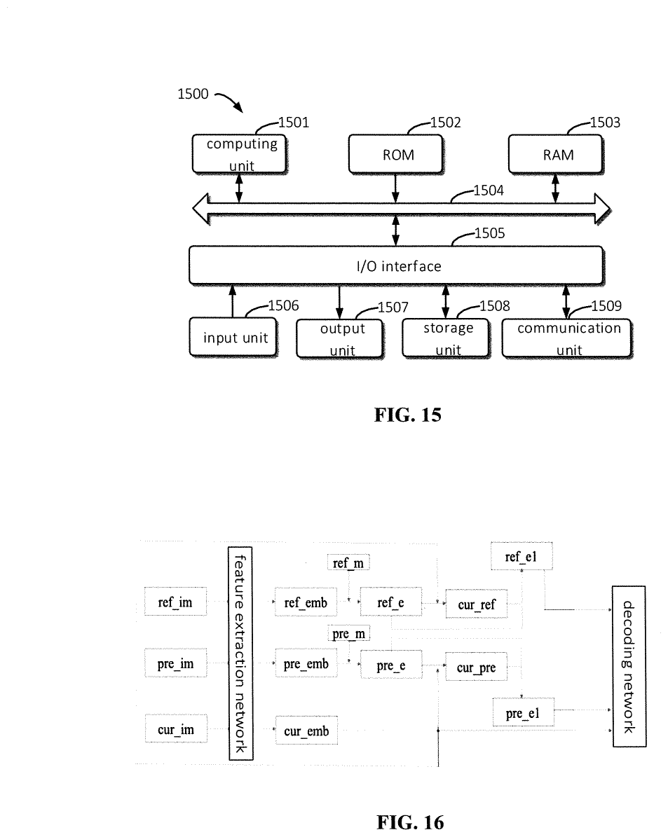

FIG. 15 is a block diagram of an example electronic device 1500 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 15, the device 1500 includes a computing unit 1501 performing various appropriate actions and processes based on computer programs stored in a read-only memory (ROM) 1502 or computer programs loaded from the storage unit 1508 to a random access memory (RAM) 1503. In the RAM 1503, various programs and data required for the operation of the device 1500 are stored. The computing unit 1501, the ROM 1502, and the RAM 1503 are connected to each other through a bus 1504. An input/output (I/O) interface 1505 is also connected to the bus 1504.

Components in the device 1500 are connected to the I/O interface 1505, including: an inputting unit 1506, such as a keyboard, a mouse; an outputting unit 1507, such as various types of displays, speakers; a storage unit 1508, such as a disk, an optical disk; and a communication unit 1509, such as network cards, modems, and wireless communication transceivers. The communication unit 1509 allows the device 1500 to exchange information/data with other devices through a computer network such as the Internet and/or various telecommunication networks.

The computing unit 1501 may be various general-purpose and/or dedicated processing components with processing and computing capabilities. Some examples of computing unit 1501 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 1501 executes the various methods and processes described above, such as the object segmentation method. For example, in some embodiments, the method may be implemented as a computer software program, which is tangibly contained in a machine-readable medium, such as the storage unit 1508. In some embodiments, part or all of the computer program may be loaded and/or installed on the device 1500 via the ROM 1502 and/or the communication unit 1509. When the computer program is loaded on the RAM 1503 and executed by the computing unit 1501, one or more steps of the method described above may be executed. Alternatively, in other embodiments, the computing unit 1501 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system to solve the problem that there are the defects of difficult management and weak business expansion in the traditional physical hosts and (Virtual Private Server) VPS services. The server may be a server of a distributed system, or a server combined with a block-chain.

It is understandable that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

1. An object segmentation method, comprising:
generating a frame to be identified, a previous frame of the frame to be identified and a reference frame based on a video to be identified, wherein the reference frame is a first frame of the video to be identified;
generating a feature map of the frame to be identified, a target object feature map of the reference frame and a target object feature map of the previous frame by inputting the frame to be identified, the previous frame and the reference frame into an encoding network;
generating a first correlation matrix and a second correlation matrix based on the feature map of the frame to be identified, the target object feature map of the reference frame and the target object feature map of the previous frame;
generating a first correlation feature map and a second correlation feature map based on the first correlation matrix, the second correlation matrix, the target object feature map of the reference frame and the target object feature map of the previous frame; and
generating an object segmentation image corresponding to a current frame based on the first correlation feature map, the second correlation feature map and the feature map of the frame to be identified.

2. The method of claim 1, wherein generating the feature map of the frame to be identified, the target object feature map of the reference frame and the target object feature map of the previous frame comprises:
generating the feature map of the frame to be identified, a feature map of the previous frame and a feature map of the reference frame by extracting features of the frame to be identified, features of the previous frame and features of the reference frame;
generating the target object feature map of the reference frame based on the feature map of the reference frame and a target object mask of the reference frame; and
generating the target object feature map of the previous frame based on the feature map of the previous frame and a target object mask of the previous frame.

3. The method of claim 1, wherein generating the first correlation matrix and the second correlation matrix based on the feature map of the frame to be identified, the target object feature map of the reference frame and the target object feature map of the previous frame comprises:
generating the first correlation matrix based on the feature map of the frame to be identified and the target object feature map of the reference frame; and
generating the second correlation matrix based on the feature map of the frame to be identified and the target object feature map of the previous frame.

4. The method of claim 3, wherein generating the first correlation matrix based on the feature map of the frame to be identified and the target object feature map of the reference frame comprises:
generating a reference correlation matrix based on the feature map of the frame to be identified and the target object feature map of the reference frame;
generating a second reference correlation matrix by normalizing the reference correlation matrix; and
generating reference values for rows of the second reference correlation matrix, and generating the first correlation matrix based on the reference values, wherein the reference value of each row is greater than other values in the same row.

5. The method of claim 3, wherein generating the second correlation matrix based on the feature map of the frame to be identified and the target object feature map of the previous frame comprises:
generating a previous frame correlation matrix based on the feature map of the frame to be identified and the target object feature map of the previous frame;
generating a second previous frame correlation matrix by normalizing the previous frame correlation matrix; and
generating reference values in rows of the second previous frame correlation matrix, and generating the second correlation matrix based on the reference values, wherein the reference value in each row is greater than other values in the same row.

6. The method of claim 1, wherein generating the first correlation feature map and the second correlation feature map based on the first correlation matrix, the second correlation matrix, the target object feature map of the reference frame and the target object feature map of the previous frame comprises:
generating the first correlation feature map by performing point-to-point multiplication on the first correlation matrix and the target object feature map of the reference frame; and
generating the second correlation feature map by performing point-to-point multiplication on the second correlation matrix and the target object feature map of the previous frame.

7. The method of claim 1, wherein generating the object segmentation image of the current frame based on the first correlation feature map, the second correlation feature map and the feature map of the frame to be identified comprises:
generating a fusion feature map based on the first correlation feature map, the second correlation feature map and the feature map of the frame to be identified; and
generating the object segmentation image of the current frame by inputting the fusion feature map into a decoding network.

8. The method of claim 7, wherein generating the fusion feature map based on the first correlation feature map, the second correlation feature map and the feature map of the frame to be identified comprises:
generating the fusion feature map by concatenating the first correlation feature map, the second correlation feature map and the feature map of the frame to be identified.

9-16. (canceled)

17. An electronic device, comprising:
at least one processor; and
a memory communicatively coupled to the at least one processor; wherein,
the memory stores instructions executable by the at least one processor, when the instructions are executed by the at least one processor, the at least one processor is configured to:
generate a frame to be identified, a previous frame of the frame to be identified and a reference frame based on a video to be identified, wherein the reference frame is a first frame of the video to be identified;
generate a feature map of the frame to be identified, a target object feature map of the reference frame and a target object feature map of the previous frame by inputting the frame to be identified, the previous frame and the reference frame into an encoding network;
generate a first correlation matrix and a second correlation matrix based on the feature map of the frame to be identified, the target object feature map of the reference frame and the target object feature map of the previous frame;
generate a first correlation feature map and a second correlation feature map based on the first correlation matrix, the second correlation matrix, the target object feature map of the reference frame and the target object feature map of the previous frame; and
generate an object segmentation image corresponding to a current frame based on the first correlation feature map, the second correlation feature map and the feature map of the frame to be identified.

18. A non-transitory computer-readable storage medium having computer instructions stored thereon, wherein the computer instructions are configured to cause a computer to execute an object segmentation method, the method comprising:
generating a frame to be identified, a previous frame of the frame to be identified and a reference frame based on a video to be identified, wherein the reference frame is a first frame of the video to be identified;
generating a feature map of the frame to be identified, a target object feature map of the reference frame and a target object feature map of the previous frame by inputting the frame to be identified, the previous frame and the reference frame into an encoding network;
generating a first correlation matrix and a second correlation matrix based on the feature map of the frame to be identified, the target object feature map of the reference frame and the target object feature map of the previous frame;
generating a first correlation feature map and a second correlation feature map based on the first correlation matrix, the second correlation matrix, the target object feature map of the reference frame and the target object feature map of the previous frame; and
generating an object segmentation image corresponding to a current frame based on the first correlation feature map, the second correlation feature map and the feature map of the frame to be identified.

19. (canceled)

20. The electronic device of claim 17, wherein the at least one processor is configured to:
generate the feature map of the frame to be identified, a feature map of the previous frame and a feature map of the reference frame by extracting features of the frame to be identified, features of the previous frame and features of the reference frame;
generate the target object feature map of the reference frame based on the feature map of the reference frame and a target object mask of the reference frame; and
generate the target object feature map of the previous frame based on the feature map of the previous frame and a target object mask of the previous frame.

21. The electronic device of claim 17, wherein the at least one processor is configured to:
generate the first correlation matrix based on the feature map of the frame to be identified and the target object feature map of the reference frame; and
generate the second correlation matrix based on the feature map of the frame to be identified and the target object feature map of the previous frame.

22. The electronic device of claim 21, wherein the at least one processor is configured to:
generate a reference correlation matrix based on the feature map of the frame to be identified and the target object feature map of the reference frame;
generate a second reference correlation matrix by normalizing the reference correlation matrix; and
generate reference values for rows of the second reference correlation matrix, and generate the first correlation matrix based on the reference values, wherein the reference value of each row is greater than other values in the same row.

23. The electronic device of claim 21, wherein the at least one processor is configured to:
generate a previous frame correlation matrix based on the feature map of the frame to be identified and the target object feature map of the previous frame;
generate a second previous frame correlation matrix by normalizing the previous frame correlation matrix; and
generate reference values in rows of the second previous frame correlation matrix, and generate the second correlation matrix based on the reference values, wherein the reference value in each row is greater than other values in the same row.

24. The electronic device of claim 17, wherein the at least one processor is configured to:
generate the first correlation feature map by performing point-to-point multiplication on the first correlation matrix and the target object feature map of the reference frame; and
generate the second correlation feature map by performing point-to-point multiplication on the second correlation matrix and the target object feature map of the previous frame.

25. The electronic device of claim 17, wherein the at least one processor is configured to:
generate a fusion feature map based on the first correlation feature map, the second correlation feature map and the feature map of the frame to be identified; and
generate the object segmentation image of the current frame by inputting the fusion feature map into a decoding network.

26. The electronic device of claim 25, wherein the at least one processor is configured to:
generate the fusion feature map by concatenating the first correlation feature map, the second correlation feature map and the feature map of the frame to be identified.

27. The non-transitory computer-readable storage medium of claim 18, wherein generating the feature map of the frame to be identified, the target object feature map of the reference frame and the target object feature map of the previous frame comprises:
generating the feature map of the frame to be identified, a feature map of the previous frame and a feature map of the reference frame by extracting features of the frame to be identified, features of the previous frame and features of the reference frame;
generating the target object feature map of the reference frame based on the feature map of the reference frame and a target object mask of the reference frame; and
generating the target object feature map of the previous frame based on the feature map of the previous frame and a target object mask of the previous frame.

28. The non-transitory computer-readable storage medium of claim 18, wherein generating the first correlation matrix and the second correlation matrix based on the feature map of the frame to be identified, the target object feature map of the reference frame and the target object feature map of the previous frame comprises:
generating the first correlation matrix based on the feature map of the frame to be identified and the target object feature map of the reference frame; and
generating the second correlation matrix based on the feature map of the frame to be identified and the target object feature map of the previous frame.

29. The non-transitory computer-readable storage medium of claim 28, wherein generating the first correlation matrix based on the feature map of the frame to be identified and the target object feature map of the reference frame comprises:
generating a reference correlation matrix based on the feature map of the frame to be identified and the target object feature map of the reference frame;
generating a second reference correlation matrix by normalizing the reference correlation matrix; and
generating reference values for rows of the second reference correlation matrix, and generating the first correlation matrix based on the reference values, wherein the reference value of each row is greater than other values in the same row.
